(19) United States
(12) Patent Application Publication
(10) Pub. No.: US 2026/0114516 A1
(43) Pub. Date: Apr. 30, 2026

(54) METHOD OF CONTROLLING HEATER AND AEROSOL GENERATING DEVICE PERFORMING THE METHOD

(71) Applicant: KT&G CORPORATION, Daejeon (KR)

(72) Inventors: Byung Sung CHO, Gyeonggi-do (KR); Sang Joon KIM, Gyeonggi-do (KR); Sang Kyu PARK, Seoul (KR); Jaemin LEE, Gyeonggi-do (KR); Se Hwan JUNG, Gyeonggi-do (KR)

(73) Assignee: KT&G CORPORATION, Daejeon (KR)

(21) Appl. No.: 19/321,396

(22) Filed: Sep. 8, 2025

(30) Foreign Application Priority Data
Oct. 25, 2024 (KR) 10-2024-0147524
Oct. 25, 2024 (KR) 10-2024-0147527
Nov. 4, 2024 (KR) 10-2024-0154475

(51) Int. Cl. A24F 40/57; A24F 40/10; A24F 40/51; A24F 40/53; A24F 40/60; H05B 1/02

(52) U.S. Cl. CPC A24F 40/57; A24F 40/10; A24F 40/51; A24F 40/53; A24F 40/60; H05B 1/0225

(57) ABSTRACT

A method of controlling a heater performed by an aerosol-generating device includes obtaining a first initiation command indicating a start of a first puff, when the first initiation command is obtained, controlling power supplied to the heater to heat an aerosol-generating substance based on a first power profile set to correspond to a first atomization mode, determining a first puff time during which the first puff is performed, calculating a first weighted use time value for the aerosol-generating substance based on the first atomization mode and the first puff time, calculating an accumulated use time value for the aerosol-generating substance based on the first weighted use time value, and controlling the heater based on the accumulated use time value.

### CROSS-REFERENCE TO RELATED APPLICATION

This application claims the benefit of Korean Patent Application No. 10-2024-0147524, filed on Oct. 25, 2024, Korean Patent Application No. 10-2024-0147527, filed on Oct. 25, 2024, and Korean Patent Application No. 10-2024-0154475, filed on Nov. 4, 2024, in the Korean Intellectual Property Office, the entire disclosures of which are incorporated herein by reference for all purposes.

### BACKGROUND

### 1. Field of the Invention

One or more embodiments relate to technology for controlling an aerosol-generating device, and more particularly, to a method of controlling a heater configured to heat an aerosol-generating substance in the aerosol-generating device.

### 2. Description of the Related Art

In recent years, demand for electronic cigarette devices has gradually increased. With this increasing demand, functions related to electronic cigarette devices have been continuously developed. Specifically, functions corresponding to the types and characteristics of electronic cigarette devices have been actively developed.

In general, an electronic cigarette device using an aerosol-generating substance including a liquid composition may generate an aerosol by heating the aerosol-generating substance through a heater in response to a user's puff. However, if the heater continues to operate even after the aerosol-generating substance is completely exhausted, the electronic cigarette device may provide an unpleasant smoking experience to the user or pose a risk of damage to the device.

### SUMMARY

Embodiments provide an aerosol-generating device that generates an aerosol by heating an aerosol-generating substance according to an atomization mode.

Embodiments also provide an aerosol-generating device that controls operation of a heater by calculating a usage amount or a remaining amount of the aerosol-generating substance.

Embodiments also provide an aerosol-generating device that controls operation of a heater by calculating an average usage of the aerosol-generating substance.

However, the technical goals are not limited to those described above, and other technical goals may be present.

According to an aspect, there is provided a method of controlling a heater performed by an aerosol-generating device including obtaining a first initiation command indicating a start of a first puff, when the first initiation command is obtained, controlling power supplied to the heater to heat an aerosol-generating substance based on a first power profile set to correspond to a first atomization mode, determining a first puff time during which the first puff is performed, calculating a first weighted use time value for the aerosol-generating substance based on the first atomization mode and the first puff time, calculating an accumulated use time value for the aerosol-generating substance based on the first weighted use time value, and controlling the heater based on the accumulated use time value.

According to another aspect, there is provided an aerosol-generating device including a controller configured to control an operation of the aerosol-generating device, a sensor unit configured to generate measurement data corresponding to a start of a puff, a power supply configured to supply power to the controller, a cartridge including an aerosol-generating substance, and a heater configured to heat the aerosol-generating substance, in which the controller is configured to obtain a first initiation command indicating a start of a first puff based on the measurement data, control power supplied to the heater to heat the aerosol-generating substance based on a first power profile set to correspond to a first atomization mode when the first initiation command is obtained, determine a first puff time during which the first puff is performed, calculate a first weighted use time value for the aerosol-generating substance based on the first atomization mode and the first puff time, calculate an accumulated use time value for the aerosol-generating substance based on the first weighted use time value, and control the heater based on the accumulated use time value.

According to an embodiment, a method of controlling a heater performed by an aerosol-generating device may include determining an average use time value for an aerosol-generating substance based on a puff record of the aerosol-generating device, obtaining a first initiation command indicating a start of a first puff, determining a remaining use time value for the aerosol-generating substance based on a first accumulated use time value for the aerosol-generating substance, determining whether the remaining use time value exceeds the average use time value, invalidating the first initiation command when the remaining use time value does not exceed the average use time value, and controlling the heater based on the first accumulated use time value when the remaining use time value exceeds the average use time value.

According to an embodiment, an aerosol-generating device may include a controller configured to control an operation of the aerosol-generating device, a sensor unit configured to generate measurement data corresponding to a start of a puff, a power supply configured to supply power to the controller, and a heater configured to heat an aerosol-generating substance, in which the controller is configured to determine an average use time value for the aerosol-generating substance based on a puff record of the aerosol-generating device, obtain a first initiation command indicating a start of a first puff based on the measurement data, determine a remaining use time value for the aerosol-generating substance based on a first accumulated use time value for the aerosol-generating substance, determine whether the remaining use time value exceeds the average use time value, invalidate the first initiation command when the remaining use time value does not exceed the average use time value, and control the heater based on the first accumulated use time value when the remaining use time value exceeds the average use time value.

According to an embodiment, a method of controlling a heater performed by an aerosol-generating device may include obtaining a first initiation command indicating a start of a first puff, controlling power supplied to a heater to heat an aerosol-generating substance based on a first power profile set to correspond to a first atomization mode when the first initiation command is obtained, determining a first puff time during which the first puff is performed, calculating a first liquid consumption amount for the aerosol-generating substance based on the first atomization mode and the first puff time, calculating an accumulated liquid consumption amount for the aerosol-generating substance based on the first liquid consumption amount, and controlling the heater based on the accumulated liquid consumption amount.

According to an embodiment, an aerosol-generating device may include a controller configured to control an operation of the aerosol-generating device, a sensor unit configured to generate measurement data corresponding to a start of a puff, a power supply configured to supply power to the controller, a cartridge including an aerosol-generating substance, and a heater configured to heat the aerosol-generating substance, in which the controller is configured to obtain a first initiation command indicating a start of a first puff based on the measurement data, control power supplied to the heater to heat the aerosol-generating substance based on a first power profile set to correspond to a first atomization mode when the first initiation command is obtained, determine a first puff time during which the first puff is performed, calculate a first liquid consumption amount for the aerosol-generating substance based on the first atomization mode and the first puff time, calculate an accumulated liquid consumption amount for the aerosol-generating substance based on the first liquid consumption amount, and control the heater based on the accumulated liquid consumption amount.

According to at least one embodiment of the present disclosure, an aerosol-generating device may be provided that may heat an aerosol-generating substance and generate an aerosol by controlling power supplied to a heater according to an atomization mode.

According to at least one embodiment of the present disclosure, an aerosol-generating device may be provided that may control operation of a heater by calculating a usage amount of the aerosol-generating substance consumed during a puff based on an atomization mode and a puff time.

According to at least one embodiment of the present disclosure, an aerosol-generating device may be provided that may interrupt the supply of power to the heater when it is determined that the remaining amount of the aerosol-generating substance is less than or equal to a threshold based on the usage of the aerosol-generating substance.

According to at least one embodiment of the present disclosure, an aerosol-generating device may be provided that may control operation of a heater by determining an average usage of an aerosol-generating substance based on a smoking record of the aerosol-generating device.

According to at least one embodiment of the present disclosure, an aerosol-generating device may be provided that may control operation of a heater by calculating an accumulated usage of an aerosol-generating substance based on an atomization mode and a puff time.

According to at least one embodiment of the present disclosure, an aerosol-generating device may be provided that may interrupt the supply of power to the heater when it is determined, based on an accumulated usage of the aerosol-generating substance, that a remaining amount of the aerosol-generating substance is less than or equal to an average usage.

According to at least one embodiment of the present disclosure, an aerosol-generating device may be provided that may heat an aerosol-generating substance and generate an aerosol by controlling power supplied to a heater according to an atomization mode.

According to at least one embodiment of the present disclosure, an aerosol-generating device may be provided that may control operation of a heater by calculating a usage amount of the aerosol-generating substance consumed during a puff based on an atomization mode and a puff time.

According to at least one embodiment of the present disclosure, an aerosol-generating device may be provided that may interrupt the supply of power to the heater when it is determined that a remaining amount of the aerosol-generating substance is less than or equal to a threshold based on a usage amount of the aerosol-generating substance.

### BRIEF DESCRIPTION OF THE DRAWINGS

FIG. 1 is a block diagram of an aerosol-generating device according to an embodiment.

FIG. 2 shows an aerosol-generating device according to an embodiment.

FIG. 3 shows an aerosol-generating device according to an embodiment.

FIG. 4 is a flowchart of a method of controlling a heater according to an embodiment.

FIG. 5 is a flowchart of a method of obtaining a first initiation command according to an example.

FIG. 6 is a flowchart of a method of determining a first atomization mode according to an example.

FIG. 7 is a flowchart of a method of controlling power supplied to a heater according to an example.

FIG. 8 is a flowchart of a method of calculating a first weighted use time value for an aerosol-generating substance according to an example.

FIG. 9 is a flowchart of a method of controlling a heater based on an accumulated use time value during a first puff according to an example.

FIG. 10 is a flowchart of a method of determining a first puff time according to an example.

FIG. 11 is a flowchart of a method of controlling a heater based on an accumulated use time value after a second initiation command is obtained according to an example.

FIG. 12 is a flowchart of a method of outputting a notification indicating that the aerosol-generating substance has been exhausted according to an example.

FIG. 13 is a flowchart of a method of controlling a heater according to an embodiment.

FIG. 14 is a flowchart of a method of determining a first atomization mode based on a puff pattern according to an example.

FIG. 15 is a flowchart of a method of determining a plurality of average use time values according to an example.

FIG. 16 is a flowchart of a method of controlling a heater based on a first accumulated use time value according to an example.

FIG. 17 is a flowchart of a method of controlling a heater based on a second accumulated use time value after a second initiation command is obtained according to an example.

FIG. 18 is a flowchart of a method of controlling a heater according to an embodiment.

FIG. 19 is a flowchart of a method of calculating a first liquid consumption amount for an aerosol-generating substance according to an example.

FIG. 20 is a flowchart of a method of controlling a heater based on an accumulated liquid consumption amount during a first puff according to an example.

FIG. 21 is a flowchart of a method of controlling a heater based on an accumulated liquid consumption amount after a second initiation command is obtained according to an example.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

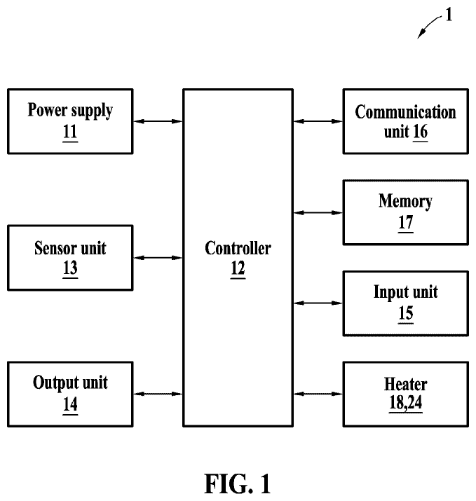

FIG. 1 is a block diagram of an aerosol-generating device according to an embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change and/or aerosol flow may occur in the insertion space of the aerosol-generating article, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

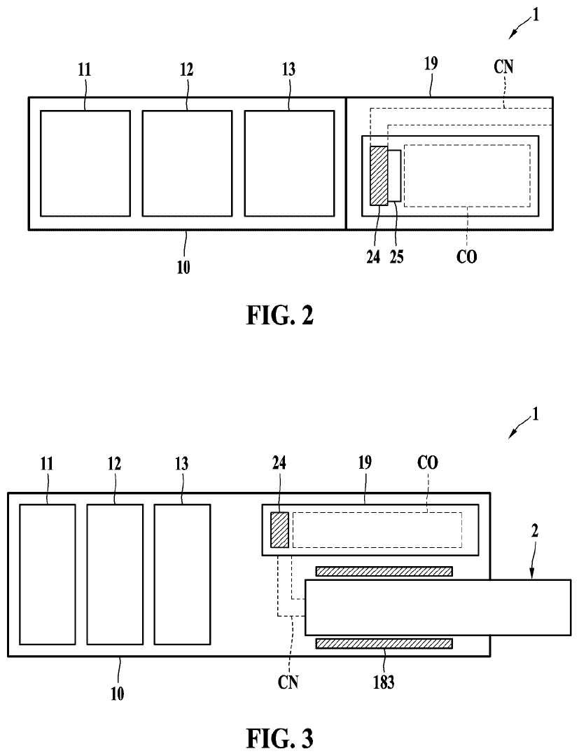

FIG. 2 shows an aerosol-generating device 1 according to an embodiment.

According to one embodiment, the aerosol-generating device 1 may include a housing 10, a power supply 11, a controller 12, and/or a sensor unit 13. However, it will be understood by those skilled in the art related to the present embodiment that the components included in the aerosol-generating device 1 are not limited to those shown in FIG. 2 and that some of the components may be omitted or new components may be further included. In the drawings below, a description of configurations identical to those shown in FIG. 1 will be omitted.

According to one embodiment, the housing 10 may include a structure that allows a cartridge 19 to be inserted into or mounted on one side thereof. In this case, the cartridge 19 may be removably coupled to the housing 10.

Although not shown in the drawings, the housing 10 and/or the cartridge 19 may include a mouthpiece. A user may inhale an aerosol while holding the mouthpiece in the mouth.

According to one embodiment, the cartridge 19 may include a chamber CO containing an aerosol-generating substance. The chamber CO may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance.

According to one embodiment, a liquid delivery part 25 that is impregnated with (contains) the aerosol-generating substance may be included in the cartridge 19. For example, the liquid delivery part 25 may be impregnated with the aerosol-generating substance supplied from the chamber CO. Here, the liquid delivery part 25 may include a wick formed of, e.g., cotton fiber, ceramic fiber, glass fiber, or porous ceramic. Although not shown in the drawings, the aerosol-generating device 1 may further include a liquid delivery part. In this case, at least a portion of the first liquid delivery part of the cartridge 19 and at least a portion of the second liquid delivery part of the aerosol-generating device 1 may be formed in contact with each other. In this case, the first liquid delivery part and the second liquid delivery part may be implemented in different forms. For example, the first liquid delivery part may include cotton fiber, and the second liquid delivery part may include porous ceramic. Alternatively, the cartridge 19 may not include a liquid delivery part, and the aerosol-generating substance in the cartridge 19 may be delivered to the liquid delivery part of the aerosol-generating device 1.

According to one embodiment, the housing 10 and/or the cartridge 19 may be provided with an airflow channel through which air flows.

For example, the housing 10 may include a structure allowing outside air to be introduced into the housing 10 in the state in which the cartridge 19 is coupled thereto. In an example, an air inlet through which outside air may be introduced into the housing 10 may be formed in one side surface of the housing 10. The air inlet may also be formed in the lower end surface of the housing 10. Outside air introduced into the housing 10 through the air inlet may pass through the cartridge 19, and then may flow toward the user's oral cavity through the airflow channel CN. The outside air introduced through the air inlet may flow to the user's oral cavity through the airflow channel CN via the cartridge 19.

For example, the airflow channel CN may be included in the cartridge 19. The airflow channel CN may connect the chamber (e.g., an atomization chamber) in which the cartridge heater 24 or the liquid delivery part 25 is disposed to the outside of the housing 10 and/or the cartridge 19. In more detail, one end of the airflow channel CN may be open to the chamber (e.g., the atomization chamber) in which the cartridge heater 24 or the liquid delivery part 25 is disposed, and the other end thereof may communicate with the mouthpiece. The airflow channel CN may be elongated from one side of the chamber CO of the cartridge 19 in the longitudinal direction of the cartridge 19. The airflow channel CN may also be elongated in the longitudinal direction of the cartridge 19 through the chamber CO of the cartridge 19. The airflow channel CN may also communicate with a separate mouthpiece provided at the housing 10.

According to one embodiment, the cartridge heater 24 may heat the aerosol-generating substance contained in the cartridge 19. For example, the cartridge heater 24 may include an electro-resistive heater and/or an induction heater. In an example, the electro-resistive heater may include an electro-resistive material, and may generate heat as current flows through the electro-resistive material. In another example, in the case of an induction heater, the aerosol-generating device 1 may include an induction coil (not shown) provided around the induction heater. The induction heater may include a susceptor, and may generate heat based on a magnetic field generated by the induction coil (not shown). The cartridge heater 24 may be formed in a coil shape surrounding (or wound around) the liquid delivery part included in the cartridge 19 and/or the aerosol-generating device 1 and/or in a shape (e.g., a pattern shape) contacting one side of the liquid delivery part.

According to one embodiment, the cartridge heater 24 may be included in the cartridge 19. If the cartridge 19 is formed to be removable from the housing 10, the cartridge heater 24 may be removed from the aerosol-generating device 1 together with the cartridge 19. Unlike the configuration shown in the drawings, the cartridge heater 24 may be included in the aerosol-generating device 1. For example, the cartridge heater 24 may be included inside the housing 10. Meanwhile, the cartridge heater 24 may be included in a form that is removable from the housing 10 separately from (i.e., independently of) the cartridge 19. In other words, the cartridge heater 24 may or may not be removed from the housing 10 regardless of removal of the cartridge 19.

According to one embodiment, an aerosol may be generated based on generation of heat by the cartridge heater 24. As the liquid delivery part 25 is heated by the cartridge heater 24, an aerosol may be generated. For example, as the aerosol-generating substance impregnated in the liquid delivery part 25 is heated by the cartridge heater 24, vapor may be generated from the aerosol-generating substance, and an aerosol may be generated as the generated vapor is mixed with the outside air introduced into the cartridge 19. The aerosol generated by the cartridge heater 24 may be inhaled into the user's oral cavity through the airflow channel CN.

According to one embodiment, the cartridge 19 may be integrally formed with the aerosol-generating device 1 (e.g., the housing 10). The cartridge 19 may be formed so as not to be removed from the aerosol-generating device 1 by the user. Even in this case, the cartridge 19 and/or the aerosol-generating device 1 may include at least one liquid delivery part, and an aerosol may be generated based on heating of the liquid delivery part 25 by the cartridge heater 24 included in the aerosol-generating device 1 or the cartridge 19. The generated aerosol may be inhaled into the user's oral cavity through the airflow channel CN. FIG. 3 shows an aerosol-generating device 1 according to an embodiment.

According to one embodiment, the aerosol-generating device 1 may include a housing 10, a power supply 11, a controller 12, a sensor unit 13, and/or a heater 183 and 24 (e.g., the heater 18 and 24 in FIG. 1). However, it will be understood by those skilled in the art related to the present embodiment that the components included in the aerosol-generating device 1 are not limited to those shown in FIG. 3 and that some of the components may be omitted or new components may be further included. In the drawings below, a description of configurations identical to those shown in FIG. 1 will be omitted.

According to one embodiment, the housing 10 may provide a space that is open upwardly to allow the aerosol-generating article 2 to be inserted thereinto (hereinafter referred to as an insertion space). The insertion space may be formed so as to be depressed in the housing 10 to a predetermined depth so that at least a portion of the aerosol-generating article 2 may be inserted thereinto. The lower end of the aerosol-generating article 2 may be inserted into the housing 10, and the upper end of the aerosol-generating article 2 may protrude outside the housing 10.

Unlike the configuration shown in the drawings, the cartridge 19 may provide an insertion space for receiving the aerosol-generating article 2. In this case, the insertion space may be formed so as to be depressed in the cartridge 19 to a predetermined depth so that at least a portion of the aerosol-generating article 2 may be inserted thereinto. The lower end of the aerosol-generating article 2 may be inserted into the cartridge 19, and the upper end of the aerosol-generating article 2 may protrude outside the cartridge 19. In this case, the aerosol-generating device 1 may not include the heater 183.

According to one embodiment, the depth of the insertion space may be equal to or greater than the length of a region of the aerosol-generating article 2 in which an aerosol-generating substance and/or a medium is contained. A user may inhale air while holding the externally exposed upper end of the aerosol-generating article 2 in the mouth.

According to one embodiment, the heater 183 may heat the aerosol-generating article 2. The heater 183 may be elongated upwardly around the space into which the aerosol-generating article 2 is inserted (i.e., the insertion space). In an example, the heater 183 may have a tube shape (e.g., a cylindrical shape) with a cavity formed therein. The heater 183 may include a shape including a cavity formed therein and surrounding the cavity. In this case, the heater 183 may be supported by a polyimide film. The heater supported by this film may be referred to as a film heater. The heater 183 may be disposed so as to surround at least a portion of the insertion space. The heater 183 may heat the outer side of the aerosol-generating article 2 inserted into the cavity. In the present disclosure, the heater 183 may be referred to as an external heating-type heater, which heats the outer side of the aerosol-generating article 2. Meanwhile, a thermally insulating material may be disposed outside the heater 183. Accordingly, the amount of heat emitted from the heater 183 in the radially outward direction and released outside the housing 10 may be reduced.

According to one embodiment, the heater 183 may include an electro-resistive heater and/or an induction heater.

For example, the electro-resistive heater may include an electro-resistive material, and may generate heat as current flows through the electro-resistive material. In this case, the electro-resistive heater may be electrically connected to the power supply 11, and may directly generate heat using current received from the power supply 11.

For example, in the case of an induction heater, the aerosol-generating device 1 may further include an induction coil (not shown) surrounding at least a portion of the heater 183 (e.g., disposed outside the heater 183 so as to correspond to the length of at least a portion of the heater 183). In this case, a magnetic flux concentrator may be further provided outside the induction coil (not shown) in order to increase efficiency of induction heating. The induction heater may include a susceptor, and may generate heat based on a magnetic field generated by the induction coil (not shown).

According to one embodiment, the heater 183 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 183 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively. In addition, three or more heaters and/or three or more induction coils may be included.

Unlike the configuration shown in the drawings, the aerosol-generating device 1 may not include the heater 183. The aerosol-generating article 2 may be directly or indirectly heated by the cartridge heater 24 or may not be substantially heated. Indirect heating may mean that the aerosol-generating article 2 is heated by receiving heat contained in the aerosol during the process in which the aerosol generated by the cartridge heater 24 passes through the aerosol-generating article 2. In this case, the aerosol-generating device 1 may be referred to as a non-heating-type (or indirect heating-type) aerosol-generating device. An additive such as an alkaline substance may be contained in the aerosol-generating rod of the aerosol-generating article 2. Based on the alkaline substance, nicotine contained in the aerosol-generating rod may have an alkaline pH (e.g., pH 7.0 or higher). This alkaline nicotine may flow to the user's oral cavity together with the aerosol introduced into the aerosol-generating article 2 from the cartridge 19 to be described later.

Unlike the configuration shown in the drawings, the heater 183 may include an internal heating-type heater. For example, the internal heating-type heater may include various heating elements, such as a rod-shaped heating element, a tubular heating element, a plate-shaped heating element, or a needle-shaped heating element. The internal heating-type heater may be inserted through the lower portion of the aerosol-generating article 2, and may be set to heat the inner side of the aerosol-generating article 2.

According to one embodiment, the cartridge 19 may be removably coupled to the housing 10. For example, a space may be formed in one side of the housing 10, and at least a portion of the cartridge 19 may be inserted into the space formed in one side of the housing 10 so that the cartridge 19 is mounted to the housing 10. Alternatively, the cartridge 19 may be integrally formed with the housing 10.

According to one embodiment, the aerosol-generating device 1 and/or the cartridge 19 may be provided with an airflow channel through which air flows. For example, the housing 10 may include a structure allowing outside air to be introduced into the housing 10 in the state in which the cartridge 19 is inserted thereinto. The introduced air may pass through the cartridge 19, may be introduced into the insertion space through the airflow channel CN, and then may flow to the user's oral cavity. The airflow channel CN may include various structures for reducing residual droplets or making the flow of air smooth.

Although it is illustrated in FIG. 3 that the cartridge 19 is located beside the aerosol-generating article 2 and the airflow channel CN is formed from the side surface of the aerosol-generating article 2 to the lower end (i.e., upstream side) of the aerosol-generating article 2, the positions of the cartridge 19 and the airflow channel CN are not limited thereto. For example, the cartridge 19 may be located adjacent to the lower end (i.e., upstream side) of the aerosol-generating article 2. In this case, the airflow channel CN may be formed in a substantially straight shape to connect the cartridge 19 to the lower end (i.e., upstream side) of the aerosol-generating article 2.

According to one embodiment, the cartridge 19 may include a storage part CO that contains an aerosol-generating substance, a cartridge heater 24, and/or a liquid delivery part that is impregnated with (contains) the aerosol-generating substance. The liquid delivery part 25 may be impregnated with the aerosol-generating substance supplied from the chamber CO. For example, the liquid delivery part may include a wick formed of, e.g., cotton fiber, ceramic fiber, glass fiber, or porous ceramic.

According to one embodiment, the cartridge heater 24 may heat the aerosol-generating substance contained in the cartridge 19. For example, the cartridge heater 24 may include an electro-resistive heater and/or an induction heater.

In an example, the electro-resistive heater may include an electro-resistive material, and may generate heat as current flows through the electro-resistive material. In another example, in the case of an induction heater, the aerosol-generating device 1 may further include an induction coil (not shown) provided around the induction heater. The induction heater may include a susceptor, and may generate heat based on a magnetic field generated by the induction coil (not shown). The cartridge heater 24 may be formed in a coil shape surrounding (or wound around) the liquid delivery part and/or in a shape (e.g., a patterned shape) contacting one side of the liquid delivery part.

Unlike the configuration shown in the drawings, the cartridge heater 24 may be included in the aerosol-generating device 1. For example, the cartridge heater 24 may be included inside the housing 10. In this case, the cartridge 19 and the cartridge heater 24 may be separated by removal of the cartridge 19.

According to one embodiment, an aerosol may be generated based on generation of heat by the cartridge heater 24. For example, as the aerosol-generating substance impregnated in the liquid delivery part is heated by the cartridge heater 24, vapor may be generated from the aerosol-generating substance, and an aerosol may be generated as the generated vapor is mixed with the outside air introduced into the cartridge 19. The aerosol generated by the cartridge heater 24 may be introduced into the aerosol-generating article 2 through the airflow channel CN. While the aerosol passes through the aerosol-generating article 2, tobacco or a flavoring substance may be added to the aerosol, and the aerosol containing the tobacco or the flavoring substance may be inhaled into the user's oral cavity through one end of the aerosol-generating article 2.

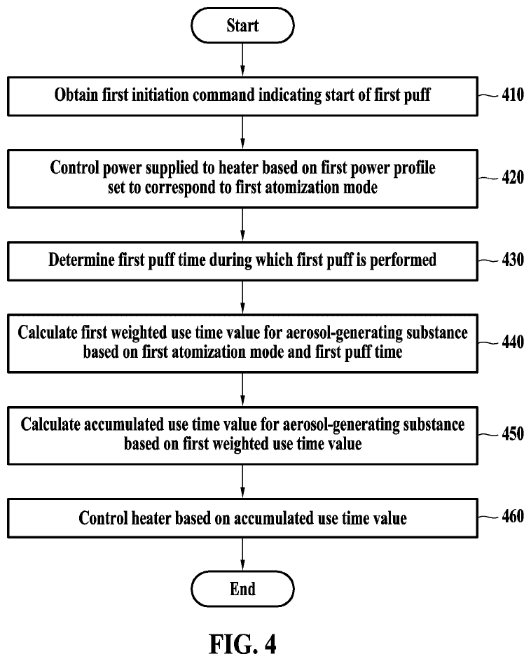

FIG. 4 is a flowchart of a method of controlling a heater according to an embodiment.

Operations 410 to 460 may be performed by an aerosol-generating device (e.g., the aerosol-generating device 1 of FIGS. 1 to 3). The aerosol-generating device may include the heater (e.g., the heater 24 of FIGS. 1 to 3), a sensor unit (e.g., the sensor unit 13 of FIGS. 1 to 3), and a controller (e.g., the controller 12 of FIGS. 1 to 3).

In operation 410, the aerosol-generating device may obtain a first initiation command indicating a start of a first puff. For example, the sensor unit may generate measurement data corresponding to the start of a puff, and the controller may obtain the first initiation command based on the measurement data generated by the sensor unit. The measurement data may be, for example, data indicating whether an input is received through a heating button of the aerosol-generating device. The measurement data may also be, for example, data indicating a pressure of an airflow path through which gas flows in the aerosol-generating device.

In operation 420, the aerosol-generating device may control power supplied to a heater based on a first power profile set to correspond to a first atomization mode. For example, the controller may generate a signal using a PWM method such that a desired amount of power is supplied to the heater.

According to one embodiment, the aerosol-generating device may operate in any one of a plurality of atomization modes. For example, the first atomization mode may be a general mode, and a second atomization mode may be a boost mode, and the functions, purposes, and names of the atomization modes are not limited to the disclosed embodiments. A power profile may be set for each of the plurality of atomization modes. Table 1 below shows a plurality of power profiles for the plurality of atomization modes.

TABLE 1

| | First | Second | Third | Fourth | Fifth | Sixth |
|---|---|---|---|---|---|---|
| | section | section | section | section | section | section |
| First | 6 W | 6 W | 5.5 W | 5.5 W | 5 W | 5 W |
| power | | | | | | |
| profile | | | | | | |
| Second | 8 W | 8 W | 7.5 W | 7.5 W | 7 W | 7 W |
| power | | | | | | |
| profile | | | | | | |

For example, each of the power profiles may define the time during which a puff is performed as the x-axis based on a plurality of sections and define the amount of power supplied to the heater in each of the sections to correspond to an atomization mode as the y-axis. For example, each power profile may include sections in which the amount of power supplied to the heater is maintained, then decreased and maintained again. Although Table 1 shows that the power values of the power profiles vary across the sections, the power profiles may instead be set to have the same power value across all the sections. For example, the first section may be a section from the start of the puff to 0.5 seconds, the second section may be from 0.5 to 1 second, the third section may be from 1 to 1.5 seconds, the fourth section may be from 1.5 to 2 seconds, the fifth section may be from 2 to 2.5 seconds, and the sixth section may be a section of 2.5 seconds or more. However, the described embodiment is not limited thereto.

According to one embodiment, the aerosol-generating device may determine the first atomization mode among the plurality of atomization modes. For example, the first atomization mode may be a general mode. For example, the aerosol-generating device may determine the first atomization mode among the plurality of atomization modes based on a mode selection input by a user. For example, the aerosol-generating device may determine the first atomization mode among the plurality of atomization modes based on a puff pattern corresponding to the first puff. A method of determining the first atomization mode among the plurality of atomization modes of the aerosol-generating device will be described in detail below with reference to FIG. 6.

In operation 430, the aerosol-generating device may determine a first puff time during which the first puff is performed. For example, the aerosol-generating device may count the first puff time during the first puff. For example, after the first puff terminates, the aerosol-generating device may determine the first puff time as a difference between a time at which the first initiation command indicating the start of the first puff is obtained and a time at which the first termination command indicating the end of the first puff is obtained.

In operation 440, the aerosol-generating device may calculate a first weighted use time value for an aerosol-generating substance based on the first atomization mode and the first puff time. The term “use time value” as used in the present disclosure does not refer to an absolute amount of time during which the aerosol-generating device is used, but rather to a value representing a degree to which the aerosol-generating substance is consumed, obtained by multiplying the time during which the aerosol-generating device is used by a weight. A method of calculating the first weighted use time value corresponding to the first puff will be described in detail below with reference to FIG. 8.

According to one embodiment, the aerosol-generating substance may include a liquid composition. If the aerosol-generating substance is a liquid substance, the degree to which the aerosol-generating substance is consumed may be estimated based only on the power supplied to the heater corresponding to the atomization mode and the puff time.

In operation 450, the aerosol-generating device may calculate an accumulated use time value for the aerosol-generating substance based on the first weighted use time value. For example, the aerosol-generating device may calculate the accumulated use time value corresponding to a mounted cartridge. For example, the aerosol-generating device may calculate the accumulated use time value corresponding to the device. The aerosol-generating device may calculate the accumulated use time value by summing all the weighted use time values calculated for each previously performed puff.

In operation 460, the aerosol-generating device may control the heater based on the accumulated use time value. For example, the aerosol-generating device may control the operation of the heater corresponding to the ongoing first puff based on the accumulated use time value. For example, the aerosol-generating device may control the operation of the heater corresponding to a second puff subsequently performed, based on the accumulated use time value.

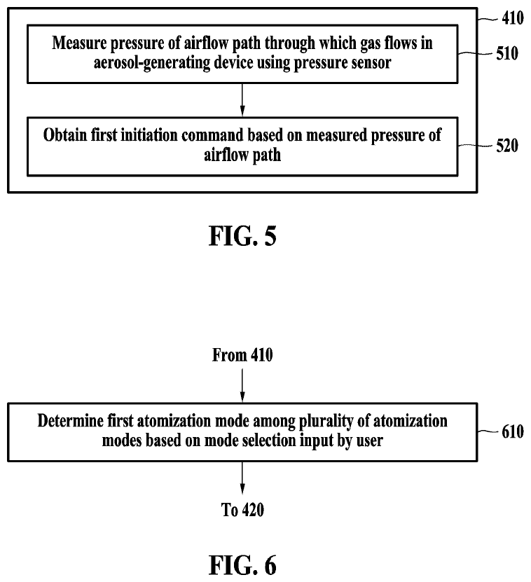

FIG. 5 is a flowchart of a method of obtaining a first initiation command according to an example.

Operations 510 and 520 may be performed by an aerosol-generating device (e.g., the aerosol-generating device 1 of FIGS. 1 to 3). The aerosol-generating device may include a heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 410 described above with reference to FIG. 4 may include operations 510 and 520.

According to one embodiment, the sensor unit of the aerosol-generating device may include a puff sensor, and the controller may obtain the first initiation command indicating a start of a first puff using the puff sensor. For example, the puff sensor may include a pressure sensor. The aerosol-generating device may detect the start of a puff using the puff sensor and heat an aerosol-generating substance. The aerosol-generating device may accurately obtain a puff time during which the aerosol-generating substance is consumed and estimate a degree to which the aerosol-generating substance is consumed based on the puff time.

In operation 510, the aerosol-generating device may measure the pressure of an airflow path through which gas flows in the aerosol-generating device using the pressure sensor.

In operation 520, the aerosol-generating device may obtain the first initiation command based on the measured pressure of the airflow path. For example, if the pressure in the airflow path in a direction toward a user's oral cavity increases to a reference value or more, the pressure sensor may generate the first initiation command. For example, if the internal pressure measured in the airflow path decreases to less than the reference value, the pressure sensor may generate the first initiation command.

According to one embodiment, the aerosol-generating device may obtain a first termination command indicating an end of the first puff based on the measured pressure of the airflow path. For example, if the pressure in the airflow path in a direction toward the user's oral cavity decreases to less than a reference value, the pressure sensor may generate the first termination command. For example, if the internal pressure measured in the airflow path increases to the reference value or more, the pressure sensor may generate the first termination command. The controller may interrupt the supply of power to the heater for the first puff in response to the first termination command.

FIG. 6 is a flowchart of a method of determining a first atomization mode according to an example.

Operation 610 may be performed by an aerosol-generating device (e.g., the aerosol-generating device 1 of FIGS. 1 to 3). The aerosol-generating device may include a heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 610 may be performed after operation 410 described above with reference to FIG. 4 and before operation 420. For example, although not illustrated as such, operation 610 may instead be performed before operation 410 described above with reference to FIG. 4.

According to one embodiment, the aerosol-generating device may generate an aerosol based on the first atomization mode by determining the first atomization mode among a plurality of atomization modes. For example, the plurality of atomization modes may include at least one of a general mode, a boost mode, and a rapid mode. The general mode may be a mode that provides a universally preferred level of throat hit or aerosol output through puffing on the aerosol-generating device. The boost mode may be a mode that provides a stronger throat hit or a greater amount of aerosol output through puffing on the aerosol-generating device. The rapid mode may be a mode that is automatically switched to when a first puff is detected as a rapid puff (e.g., when the first puff is detected within a specified time after a previous puff is detected). The plurality of atomization modes is not limited to the disclosed examples, and various atomization modes may be set to correspond to different scenarios.

In operation 610, the aerosol-generating device may determine the first atomization mode among the plurality of atomization modes based on a mode selection input by a user. For example, the aerosol-generating device may receive the mode selection input from the user before a start of the first puff. The aerosol-generating device may receive, in advance, user input indicating whether to heat an aerosol-generating substance in the general mode or in the boost mode.

According to one embodiment, the aerosol-generating device may determine a smoking pattern corresponding to the first puff and determine the first atomization mode based on at least one of the mode selection input by the user and the smoking pattern. For example, if the first puff is determined to be a rapid puff based on the recent smoking record of the user, the aerosol-generating device may automatically determine the first atomization mode as the rapid mode.

If the aerosol-generating device operates in a plurality of atomization modes, the degree to which the aerosol-generating substance is consumed may vary depending on the determined atomization mode, since power supplied to the heater is controlled based on a power profile corresponding to each atomization mode. By reflecting the determined atomization mode when calculating a weighted use time value of the aerosol-generating substance, the aerosol-generating device may more accurately estimate the degree to which the aerosol-generating substance is consumed.

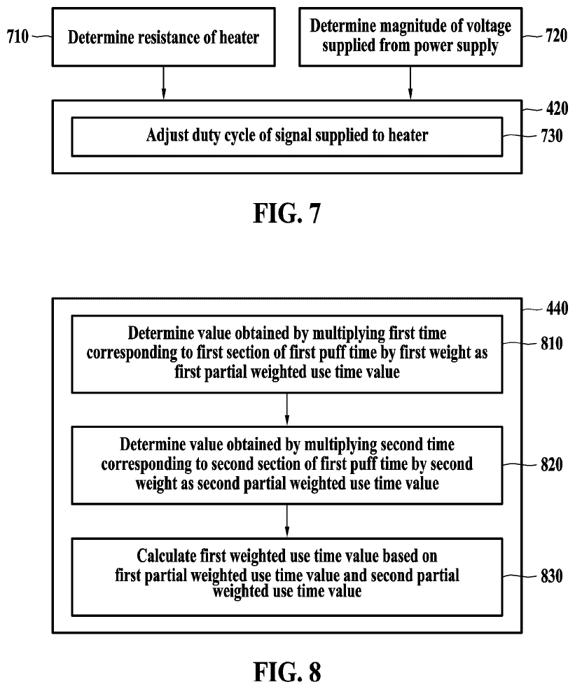

FIG. 7 is a flowchart of a method of controlling power supplied to a heater according to an example.

Operations 710 to 730 may be performed by an aerosol-generating device (e.g., the aerosol-generating device 1 of FIGS. 1 to 3). The aerosol-generating device may include a heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operations 710 and 720 may be performed before operation 420 described above with reference to FIG. 4, and operation 420 may include operation 730.

According to one embodiment, the aerosol-generating device may generate a signal using a PWM method to supply a desired amount of power to the heater. The aerosol-generating device may control power supplied to the heater by adjusting a duty cycle of the signal, based on at least one of a resistance of the heater or a magnitude of a voltage supplied from a power supply (e.g., the power supply 11 of FIGS. 1 to 3).

In operation 710, the aerosol-generating device may determine the resistance of the heater. For example, the aerosol-generating device may store the resistance of the heater determined during a design process. For example, the aerosol-generating device may determine the resistance of the heater by measuring an actual resistance of the heater. Even if the resistance of the heater is set to a specific value during the design process of the aerosol-generating device, a tolerance may occur during a manufacturing process, or the resistance of the heater may change during use. Accordingly, the aerosol-generating device may accurately control power supplied to the heater by measuring the actual resistance of the heater.

In operation 720, the aerosol-generating device may determine the magnitude of the voltage supplied from the power supply. If the power supply of the aerosol-generating device is a battery, the magnitude of the voltage of the battery may vary depending on the state of charge (SoC). Accordingly, the aerosol-generating device may accurately control the power supplied to the heater by measuring the magnitude of the voltage of the battery.

In operation 730, the aerosol-generating device may adjust the duty cycle of the signal provided to the heater. As the duty cycle of the signal provided to the heater is adjusted, the power supplied to the heater may also be adjusted.

The amount of aerosol generated corresponding to a first puff and a degree to which an aerosol-generating substance is consumed are directly correlated with the power supplied to the heater during the first puff. Accordingly, the aerosol-generating device may supply an intended amount of aerosol and accurately estimate the degree to which the aerosol-generating substance is consumed by accurately controlling the power supplied to the heater based on the resistance of the heater or the voltage supplied from the power supply.

FIG. 8 is a flowchart of a method of calculating a first weighted use time value for an aerosol-generating substance according to an example.

Operations 810 to 830 may be performed by an aerosol-generating device (e.g., the aerosol-generating device 1 of FIGS. 1 to 3). The aerosol-generating device may include a heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 440 described above with reference to FIG. 4 may include operations 810 to 830.

According to one embodiment, the aerosol-generating device may estimate a degree to which the aerosol-generating substance is consumed during a first puff by calculating the first weighted use time value corresponding to the first puff. The aerosol-generating device may calculate the first weighted use time value by weighted-summing puff times respectively corresponding to a plurality of sections. By estimating the degree to which the aerosol-generating substance is consumed based on a first atomization mode and a first puff time, the aerosol-generating device may estimate the weighted use time value and a remaining weighted use time value even without additional sensors such as a liquid level sensor for detecting a remaining amount of the aerosol-generating substance in a cartridge, or a temperature sensor for detecting a temperature of the heater.

According to one embodiment, the aerosol-generating device may store information about a look-up table of weights respectively corresponding to the plurality of sections for each of a plurality of atomization modes. The controller may calculate the first weighted use time value using the look-up table based on the first atomization mode and the first puff time.

In operation 810, when the first puff time corresponds to a first section among a plurality of preset sections, the aerosol-generating device may determine a value obtained by multiplying a first time corresponding to the first section of a first puff time by a first weight as a first partial weighted use time value. For example, the first section may be a section from immediately after a start of the first puff to a preset first time. The first weight may be set to correspond to the first section and the first atomization mode. If the first section is a start section, the amount of aerosol generated in the first section may be less relative to the power supplied compared to other sections. Accordingly, the first weight for the first section may be less than weights for other sections.

In operation 820, when the first puff time corresponds to a second section among the plurality of preset sections, the aerosol-generating device may determine a value obtained by multiplying a second time corresponding to the second section of the first puff time by a second weight as a second partial weighted use time value. For example, the second section may be a section following the first section. For example, the second section may be a section from the first time to a preset second time. The second weight may be set to correspond to the second section and the first atomization mode. The second weight for the second section may be greater than the first weight.

In operation 830, the aerosol-generating device may calculate the first weighted use time value based on the first partial weighted use time value and the second partial weighted use time value. For example, the aerosol-generating device may calculate the first weighted use time value corresponding to the amount of the aerosol-generating substance consumed during the first puff by summing partial weighted use time values for all sections corresponding to the first puff time.

The aerosol-generating device may generate an aerosol by supplying latent heat of vaporization to the aerosol-generating substance through power supplied to the heater and may thus estimate the degree to which the aerosol-generating substance is consumed based on the first atomization mode that determines a power profile. Because heat stored in the aerosol-generating substance may accumulate as the puff time elapses during the first puff, the degree to which the aerosol-generating substance is consumed may vary even when the same amount of power is supplied to the heater. The aerosol-generating device may accurately estimate the degree to which the aerosol-generating substance is consumed during the first puff by setting a plurality of sections based on changes in the power supplied to the heater and the elapse of the puff time and determining weights respectively corresponding to the plurality of sections.

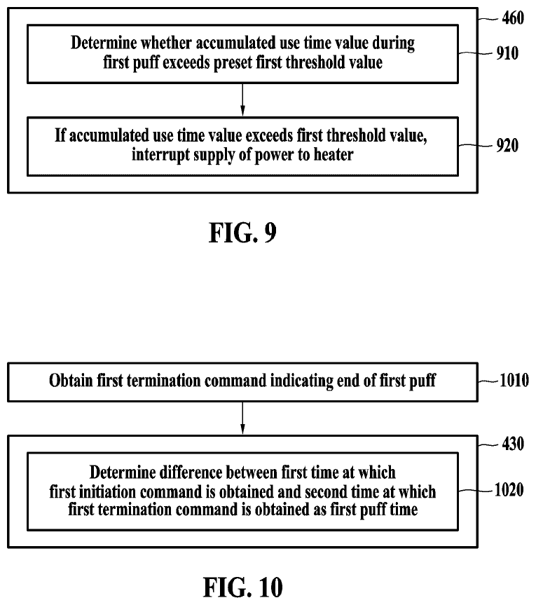

FIG. 9 is a flowchart of a method of controlling a heater based on an accumulated use time value during a first puff according to an example.

Operations 910 and 920 may be performed by an aerosol-generating device (e.g., the aerosol-generating device 1 of FIGS. 1 to 3). The aerosol-generating device may include the heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 460 described above with reference to FIG. 4 may include operations 910 and 920.

According to one embodiment, the aerosol-generating device may count the first puff time during the first puff. The aerosol-generating device may determine whether an aerosol-generating substance is exhausted by calculating the accumulated use time value that reflects, in real time, the exhaustion of the aerosol-generating substance during the first puff. If the exhaustion of the aerosol-generating substance during the first puff is reflected in real time in the accumulated use time value, the aerosol-generating device may supply a maximum amount of aerosol to the user by maximizing the consumption of the aerosol-generating substance.

In operation 910, the aerosol-generating device may determine whether the accumulated use time value during the first puff exceeds a preset first threshold value. For example, the preset first threshold value may be a value corresponding to an entire amount of the aerosol-generating substance included in a cartridge mounted in the aerosol-generating device. If the accumulated use time value exceeds the first threshold value, the aerosol-generating device may determine that the aerosol-generating substance is exhausted.

In operation 920, if the accumulated use time value exceeds the first threshold value, the aerosol-generating device may interrupt the supply of power to the heater. If it is determined that the aerosol-generating substance is exhausted, the aerosol-generating device may prevent a risk of a dry puff or damage to the device that may occur when the aerosol-generating substance is exhausted, by interrupting the supply of power to the heater.

FIG. 10 is a flowchart of a method of determining a first puff time according to an example.

Operations 1010 and 1020 may be performed by an aerosol-generating device (e.g., the aerosol-generating device 1 of FIGS. 1 to 3). The aerosol-generating device may include a heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 1010 may be performed before operation 430 described above with reference to FIG. 4, and operation 430 may include operation 1020.

According to one embodiment, the aerosol-generating device may, after obtaining a first termination command indicating an end of a first puff, calculate the first puff time and a first weighted use time value. The aerosol-generating device may reduce frequency at which an accumulated use time value of an aerosol-generating substance is calculated and conserve resources allocated for the calculation by determining the first puff time at the end of the first puff.

In operation 1010, the aerosol-generating device may obtain a first termination command indicating the end of the first puff. For example, the controller may generate the first termination command if a pressure measured in an airflow path in a direction toward the user's oral cavity decreases to less than a reference value.

In operation 1020, the aerosol-generating device may determine a difference between a first time at which a first initiation command is obtained and a second time at which the first termination command is obtained as the first puff time.

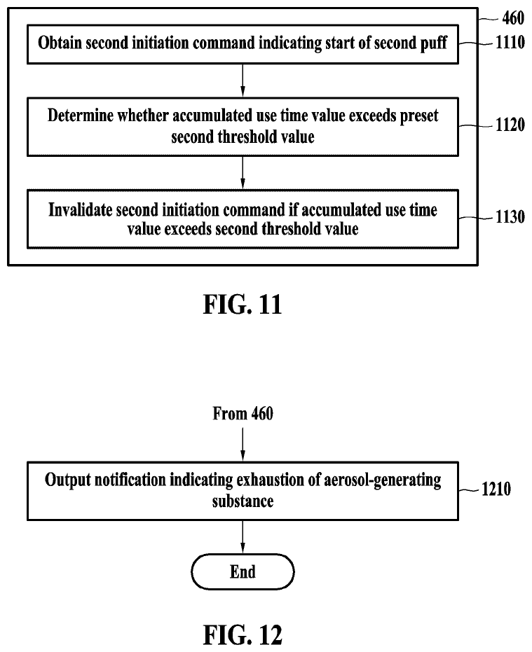

FIG. 11 is a flowchart of a method of controlling a heater based on an accumulated use time value after a second initiation command is obtained according to an example.

Operations 1110 to 1130 may be performed by an aerosol-generating device (e.g., the aerosol-generating device 1 of FIGS. 1 to 3). The aerosol-generating device may include the heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 460 described above with reference to FIG. 4 may include operations 1110 to 1130.

According to one embodiment, the aerosol-generating device may determine whether an aerosol-generating substance is exhausted at a start of a second puff following an end of a first puff. By determining whether the aerosol-generating substance is exhausted at the start of the second puff following the end of the first puff, the aerosol-generating device may prevent an aerosol from being generated when the aerosol-generating substance is insufficient in the cartridge.

In operation 1110, the aerosol-generating device may obtain the second initiation command indicating the start of the second puff. Regarding operation 1110, the description of operation 410 provided above with reference to FIG. 4 may apply in the same or a similar manner.

In operation 1120, the aerosol-generating device may determine whether the accumulated use time value exceeds a preset second threshold value. For example, the preset second threshold value may correspond to an amount of the aerosol-generating substance included in a cartridge mounted in the aerosol-generating device, excluding an amount required to perform one puff. If the accumulated use time value exceeds the second threshold value, the aerosol-generating device may determine that the remaining amount of the aerosol-generating substance in the cartridge is insufficient to perform one puff.

In operation 1130, the aerosol-generating device may invalidate the second initiation command if the accumulated use time value exceeds the second threshold value. If it is determined that the remaining amount of the aerosol-generating substance in the cartridge is insufficient to perform one puff, the aerosol-generating device may prevent a risk of a dry puff or damage to the device that may occur when the aerosol-generating substance is exhausted by interrupting the supply of power to the heater.

FIG. 12 is a flowchart of a method of outputting a notification indicating that the aerosol-generating substance has been exhausted according to an example.

Operation 1210 may be performed by an aerosol-generating device (e.g., the aerosol-generating device 1 of FIGS. 1 to 3). The aerosol-generating device may include a heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 1210 may be performed after operation 460 described above with reference to FIG. 4.

In operation 1210, the aerosol-generating device may output a notification indicating the exhaustion of the aerosol-generating substance. For example, the aerosol-generating device may output the notification when it is determined that the aerosol-generating substance is exhausted during a first puff. For example, the aerosol-generating device may output the notification when it is determined that the amount of the aerosol-generating substance is insufficient to perform a second puff at a start of the second puff. For example, the aerosol-generating device may control an output unit (e.g., the output unit 14 of FIG. 1) to provide information about the exhaustion of the aerosol-generating substance visually, tactilely, or audibly.

A user of the aerosol-generating device may recognize, through the notification, that a failure to heat the aerosol-generating substance is due to an insufficient amount of the aerosol-generating substance, and may continue smoking by replacing a cartridge of the aerosol-generating device or purchasing a new aerosol-generating device.

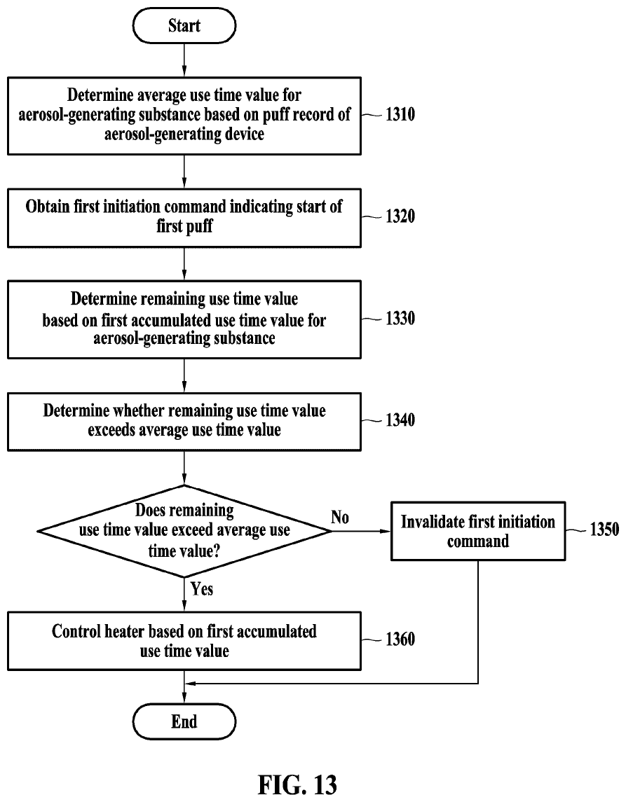

FIG. 13 is a flowchart of a method of controlling a heater according to an embodiment.

Operations 1310 to 1360 may be performed by an aerosol-generating device (e.g., the aerosol-generating device 1 of FIGS. 1 to 3). The aerosol-generating device may include the heater (e.g., the heater 24 of FIGS. 1 to 3), a sensor unit (e.g., the sensor unit 13 of FIGS. 1 to 3), and a controller (e.g., the controller 12 of FIGS. 1 to 3).

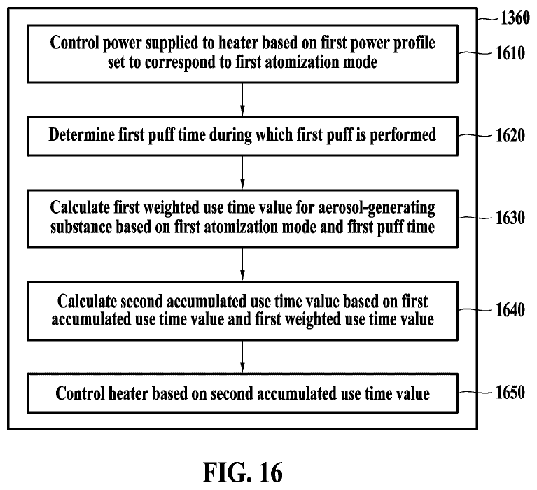

In operation 1310, the aerosol-generating device may determine an average use time value for an aerosol-generating substance based on a puff record of the aerosol-generating device. The term “use time value” as used in the present disclosure does not refer to an absolute amount of time during which the aerosol-generating device is used, but rather to a value representing a degree to which the aerosol-generating substance is consumed, obtained by multiplying the time during which the aerosol-generating device is used by a weight. A memory (e.g., the memory 17 of FIG. 1) of the aerosol-generating device may store weighted use time values corresponding to each puff previously performed. For example, the aerosol-generating device may determine an average use time value by calculating an average of at least some of the stored weighted use time values. The weighted use time values corresponding to each puff will be described in detail below with reference to FIG. 16.

According to one embodiment, the sensor unit may generate measurement data corresponding to the puff record. For example, the measurement data corresponding to the puff record may include measurement data regarding a start of a puff, an end of the puff, a duration of the puff, a current puff count, or a puff pattern of a user.

In operation 1320, the aerosol-generating device may obtain a first initiation command indicating a start of a first puff. For example, the sensor unit may generate measurement data corresponding to the start of the puff, and the controller may obtain the first initiation command indicating the start of the first puff based on the measurement data generated by the sensor unit. For example, the measurement data may be data regarding whether an input to a heating button of the aerosol-generating device is received. For example, the measurement data may be data regarding pressure of an airflow path through which gas flows in the aerosol-generating device.

According to one embodiment, the method of obtaining the first initiation command, as described above with reference to FIG. 5, may be associated with operation 1320. For example, operation 1320 may include operations 510 and 520.

In operation 1330, the aerosol-generating device may determine a remaining use time value based on a first accumulated use time value for the aerosol-generating substance. The aerosol-generating device may calculate the accumulated use time value by summing all weighted use time values calculated for each puff performed before the first puff. For example, the aerosol-generating device may store a total use time value corresponding to a mounted cartridge and determine, as the remaining use time value, a value obtained by subtracting the first accumulated use time value from the total use time value. For example, the aerosol-generating device may store a total use time value corresponding to the device and determine, as the remaining use time value, a value obtained by subtracting the first accumulated use time value from the total use time value.

In operation 1340, the aerosol-generating device may determine whether the remaining use time value exceeds the average use time value. When the remaining use time value does not exceed the average use time value, the aerosol-generating device may determine that the amount of the aerosol-generating substance remaining in the cartridge is insufficient to perform the first puff.

According to one embodiment, the method of determining the first atomization mode, as described above with reference to FIG. 6, may be associated with operations 1320 and 1340. For example, operation 610 may be performed after operation 1320 and before operation 1340. For example, operation 610 may be performed before operation 1320.

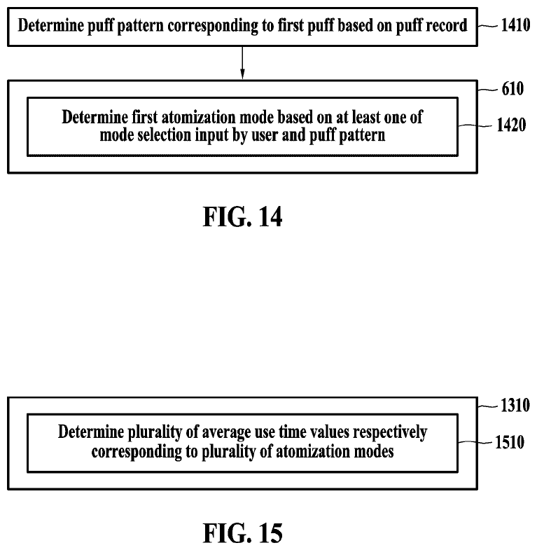

According to one embodiment, the aerosol-generating device may determine a puff pattern corresponding to the first puff and determine the first atomization mode based on at least one of a mode selection input by a user and the puff pattern. The method of determining the first atomization mode based on the puff pattern corresponding to the first puff will be described in detail below with reference to FIG. 14.

In operation 1350, when the remaining use time value does not exceed the average use time value, the aerosol-generating device may invalidate the first initiation command. When it is determined that the amount of the aerosol-generating substance remaining in the cartridge is insufficient to perform the first puff, the aerosol-generating device may prevent a risk of a dry puff or damage to the device that may occur when the aerosol-generating substance is exhausted by interrupting the supply of power to the heater.

According to one embodiment, the method of outputting a notification indicating that the aerosol-generating substance has been exhausted, as described above with reference to FIG. 12, may be associated with operation 1350. For example, operation 1210 may be performed after operation 1350. For example, when the remaining use time value does not exceed the average use time value, the aerosol-generating device may output a notification. When it is determined that the amount of the aerosol-generating substance remaining at the start of the first puff is insufficient to perform the first puff, the aerosol-generating device may provide a notification. For example, the aerosol-generating device may visually provide a notification via a display of the aerosol-generating device, tactilely provide a notification via a haptic unit, or auditorily provide a notification via a sound output unit. As long as the aerosol-generating device may convey the state of the aerosol-generating device to the user, the form of the notification is not limited to the disclosed examples.

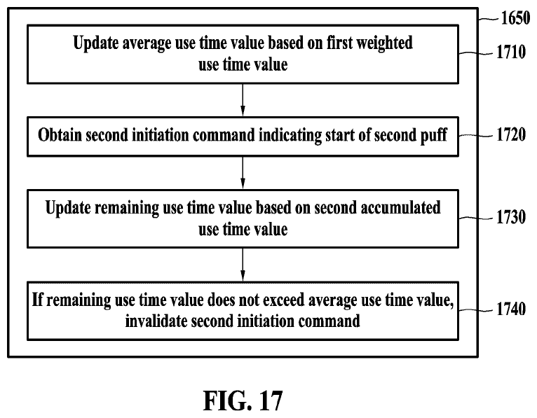

In operation 1360, when the remaining use time value exceeds the average use time value, the aerosol-generating device may control the heater based on the first accumulated use time value. For example, the aerosol-generating device may control the operation of the heater corresponding to the ongoing first puff based on the first accumulated use time value. For example, the aerosol-generating device may control the operation of the heater corresponding to a subsequently performed second puff based on the first accumulated use time value. The method of controlling the heater based on the first accumulated use time value will be described in detail below with reference to FIGS. 16 and 17.

FIG. 14 is a flowchart of a method of determining a first atomization mode based on a puff pattern according to an example.

Operations 1410 and 1420 may be performed by an aerosol-generating device (e.g., the aerosol-generating device 1 of FIGS. 1 to 3). The aerosol-generating device may include a heater (e.g., the heater 24 of FIGS. 1 to 3), a sensor unit (e.g., the sensor unit 13 of FIGS. 1 to 3), and a controller (e.g., the controller 12 of FIGS. 1 to 3).

According to one embodiment, the method of determining the first atomization mode, as described above with reference to FIG. 6, may be associated with operations 1320 and 1340. For example, operation 610 may be performed after operation 1320 and before operation 1340. Operations 1410 and 1420 may be associated with operation 610 described above with reference to FIG. 6. For example, operation 610 may be performed before operation 1320. For example, operation 1410 may be performed before operation 610, and operation 610 may include operation 1420.

According to one embodiment, the aerosol-generating device may determine a puff pattern corresponding to a first puff and determine the first atomization mode based on at least one of a mode selection input by a user and the puff pattern.

In operation 1410, the aerosol-generating device may determine the puff pattern corresponding to the first puff based on a puff record. According to one embodiment, the puff pattern may refer to a time during which the first puff is performed. For example, when the time during which the first puff is performed is greater than or equal to an average time or a preset time, the puff pattern may be determined to be an abnormal pattern.

According to one embodiment, the puff pattern may correspond to a smoking situation of the user identified based on the puff record of the aerosol-generating device. For example, the puff pattern corresponding to the first puff may be any one of a default pattern, a rapid pattern, or an abnormal pattern. For example, the default pattern may be determined when a new puff is performed after no puff has been performed for a certain time. For example, the rapid pattern may be determined when the number of puffs repeated during a certain time is less than or equal to a certain number. For example, the abnormal pattern may be determined when the number of puffs repeated during a certain time exceeds a certain number, or when a duration of a single puff is greater than or equal to a certain time. A plurality of puff patterns is not limited to the foregoing examples, and various puff patterns may be set to correspond to respective scenarios.

In operation 1420, the aerosol-generating device may determine the first atomization mode based on at least one of the mode selection input by the user and the puff pattern.

According to one embodiment, a plurality of atomization modes may further include at least one atomization mode corresponding to the plurality of puff patterns. For example, the plurality of atomization modes may further include at least one of a general-rapid mode, a boost-rapid mode, or an abnormal mode. The general-rapid mode may be an atomization mode determined when a mode selection input by the user is set to the general mode and the first puff is determined to have a rapid pattern. The boost-rapid mode may be an atomization mode determined when the mode selection input by the user is set to the boost mode and the first puff is determined to have a rapid pattern. The abnormal mode may be an atomization mode that is automatically switched to when a total number of puffs or a sum of liquid consumption amounts exceeds a reference value for a certain time, regardless of the mode selection input by the user.

The aerosol-generating device may reflect the user's preferred level of throat hit or aerosol output through the mode selection input by the user and reflect the user's smoking situation by determining a puff pattern based on the puff record.

The aerosol-generating device may provide an appropriate amount of aerosol in response to the user's preference and smoking situation through the first atomization mode determined among a plurality of atomization modes. For example, when the first atomization mode is determined to be an abnormal mode, it may be determined that the user is not in a situation of performing a puff to inhale aerosol but is instead performing a puff habitually, and thus, the aerosol-generating device may generate a reduced amount of aerosol to prevent the user from inhaling an excessive amount of aerosol and to conserve the aerosol-generating substance.

FIG. 15 is a flowchart of a method of determining a plurality of average use time values according to an example.

Operation 1510 may be performed by an aerosol-generating device (e.g., the aerosol-generating device 1 of FIGS. 1 to 3). The aerosol-generating device may include a heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 1310 described above with reference to FIG. 13 may include operation 1510.

In operation 1510, the aerosol-generating device may determine a plurality of average use time values respectively corresponding to a plurality of atomization modes. Because an amount of the aerosol-generating substance consumed for a single puff may vary depending on each of the plurality of atomization modes, the aerosol-generating device may store the plurality of average use time values respectively corresponding to the plurality of atomization modes.

According to one embodiment, the aerosol-generating device may determine only one average use time value corresponding to at least one atomization mode among the plurality of atomization modes. For example, the aerosol-generating device may determine the average use time value by calculating an average of weighted use time values for puffs performed in a general mode, a boost mode, a general-rapid mode, or a boost-rapid mode. For example, the aerosol-generating device may exclude weighted use time values of puffs performed in an abnormal mode among the plurality of atomization modes from the determination of the average use time value.

According to one embodiment, the aerosol-generating device may determine whether a remaining use time value exceeds a first average use time value corresponding to a first atomization mode among the plurality of average use time values. Because an amount of the aerosol-generating substance consumed for a single puff may vary depending on each of the plurality of atomization modes, the aerosol-generating device may determine whether a remaining amount of the aerosol-generating substance corresponding to the first atomization mode is sufficient to perform a first puff.

FIG. 16 is a flowchart of a method of controlling a heater based on a first accumulated use time value according to an example.

Operations 1610 to 1650 may be performed by an aerosol-generating device (e.g., the aerosol-generating device 1 of FIGS. 1 to 3). The aerosol-generating device may include the heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 1360 described above with reference to FIG. 13 may include operations 1610 to 1650.

In operation 1610, the aerosol-generating device may control power supplied to the heater based on a first power profile set to correspond to a first atomization mode. Regarding operation 1610, the description of operation 420 provided above with reference to FIG. 4 may apply in the same or a similar manner.

According to one embodiment, the method of controlling power supplied to the heater, as described above with reference to FIG. 7, may be associated with operation 1610. For example, operations 710 and 720 may be performed before operation 1610, and operation 1610 may include operation 730.

In operation 1620, the aerosol-generating device may determine a first puff time during which a first puff is performed. Regarding operation 1620, the description of operation 430 provided above with reference to FIG. 4 may apply in the same or a similar manner.

According to one embodiment, the method of determining the first puff time, as described above with reference to FIG. 10, may be associated with operation 1620. For example, operation 1620 may include operations 1010 and 1020.

In operation 1630, the aerosol-generating device may calculate a first weighted use time value for an aerosol-generating substance based on the first atomization mode and the first puff time. Regarding operation 1630, the description of operation 420 provided above with reference to FIG. 4 may apply in the same or a similar manner.

According to one embodiment, the method of calculating the first weighted use time value for the aerosol-generating substance, as described above with reference to FIG. 8, may be associated with operation 1630. For example, operation 1630 may include operations 810 to 830.

According to one embodiment, the aerosol-generating substance may include a liquid composition. If the aerosol-generating substance is a liquid substance, the degree to which the aerosol-generating substance is consumed may be estimated based only on the power supplied to the heater corresponding to the atomization mode and the puff time.

In operation 1640, the aerosol-generating device may calculate a second accumulated use time value based on the first accumulated use time value and the first weighted use time value. For example, the aerosol-generating device may determine, as the second accumulated use time value, a value obtained by summing the first accumulated use time value and the first weighted use time value.

In operation 1650, the aerosol-generating device may control the heater based on the second accumulated use time value. For example, the aerosol-generating device may control the operation of the heater corresponding to the ongoing first puff based on the second accumulated use time value. For example, the aerosol-generating device may control the operation of the heater corresponding to a second puff subsequently performed, based on the second accumulated use time value.

FIG. 17 is a flowchart of a method of controlling a heater based on a second accumulated use time value after a second initiation command is obtained according to an example.

Operations 1710 to 1740 may be performed by an aerosol-generating device (e.g., the aerosol-generating device 1 of FIGS. 1 to 3). The aerosol-generating device may include the heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 1650 described above with reference to FIG. 16 may include operations 1710 to 1740.

According to one embodiment, the aerosol-generating device may update an average use time value and a remaining use time value by reflecting a first puff after an end of the first puff and may determine, at a start of the second puff, whether an amount of an aerosol-generating substance is sufficient to perform a second puff. By determining whether the aerosol-generating substance is exhausted at the start of the second puff, the aerosol-generating device may prevent an aerosol from being generated when the aerosol-generating substance is insufficient in the cartridge.

In operation 1710, the aerosol-generating device may update an average use time value based on a first weighted use time value. By updating the average use time value based on the first weighted use time value, the aerosol-generating device may determine the average use time value by reflecting an amount of the aerosol-generating substance consumed during the first puff.

According to one embodiment, only when a puff pattern corresponding to the first puff is a preset pattern (e.g., a default pattern), the aerosol-generating device may update the average use time value using the first weighted use time value corresponding to the first puff. When the puff pattern corresponding to the first puff is not the preset pattern, the first weighted use time value may not be used to update the average use time value.

In operation 1720, the aerosol-generating device may obtain the second initiation command indicating the start of the second puff. Regarding operation 1720, the description of operation 420 provided above with reference to FIG. 4 may apply in the same or a similar manner.

In operation 1730, the aerosol-generating device may update the remaining use time value based on the second accumulated use time value. By updating the remaining use time value based on the second accumulated use time value, the aerosol-generating device may determine the remaining use time value as an amount of the aerosol-generating substance remaining in the cartridge after the first puff.

In operation 1740, if the remaining use time value does not exceed the average use time value, the aerosol-generating device may invalidate the second initiation command. If the remaining use time value does not exceed the average use time value, the aerosol-generating device may determine that the amount of the aerosol-generating substance remaining in the cartridge is insufficient to perform the second puff and may prevent a risk of a dry puff or damage to the device that may occur when the aerosol-generating substance has been exhausted by interrupting the supply of power to the heater.

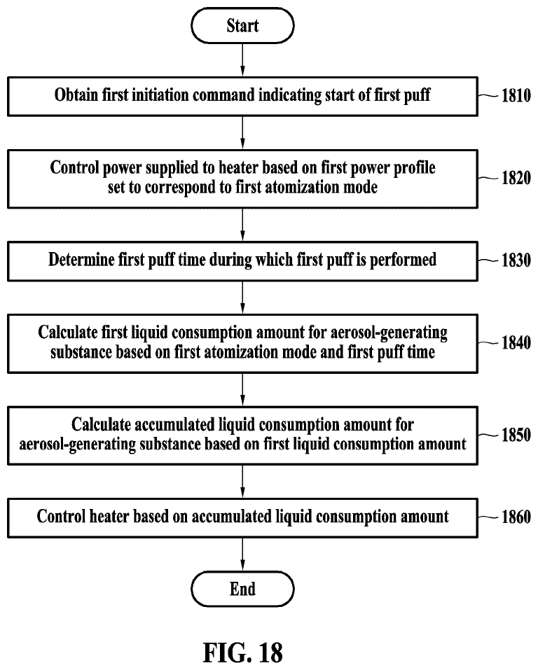

FIG. 18 is a flowchart of a method of controlling a heater according to an embodiment.

Operations 1810 to 1860 may be performed by an aerosol-generating device (e.g., the aerosol-generating device 1 of FIGS. 1 to 3). The aerosol-generating device may include the heater (e.g., the heater 24 of FIGS. 1 to 3), a sensor unit (e.g., the sensor unit 13 of FIGS. 1 to 3), and a controller (e.g., the controller 12 of FIGS. 1 to 3).

In operation 1810, the aerosol-generating device may obtain a first initiation command indicating a start of a first puff. For example, the sensor unit may generate measurement data corresponding to the start of a puff, and the controller may obtain the first initiation command indicating the start of the first puff based on the measurement data generated by the sensor unit. The measurement data may be, for example, data indicating whether an input is received through a heating button of the aerosol-generating device. The measurement data may also be, for example, data indicating a pressure of an airflow path through which gas flows in the aerosol-generating device.

According to one embodiment, the method of obtaining the first initiation command, as described above with reference to FIG. 5, may be associated with operation 1810. For example, operation 1810 may include operations 510 and 520.

In operation 1820, the aerosol-generating device may control power supplied to the heater based on a first power profile set to correspond to a first atomization mode. For example, the controller may generate a signal using a PWM method such that a desired amount of power is supplied to the heater.

According to one embodiment, the aerosol-generating device may operate in any one of a plurality of atomization modes. For example, the first atomization mode may be a general mode, and a second atomization mode may be a boost mode, and the functions, purposes, and names of the atomization modes are not limited to the disclosed embodiments. A power profile (e.g., the plurality of power profiles of Table 1) may be set for each of the plurality of atomization modes.

According to one embodiment, the aerosol-generating device may determine the first atomization mode among the plurality of atomization modes. For example, the first atomization mode may be a general mode. For example, the aerosol-generating device may determine the first atomization mode among the plurality of atomization modes based on a mode selection input by a user. For example, the aerosol-generating device may determine the first atomization mode among the plurality of atomization modes based on a puff pattern corresponding to the first puff.

According to one embodiment, the method of determining the first atomization mode, as described above with reference to FIG. 6, may be associated with operations 1810 and 1820. For example, operation 610 may be performed after operation 1810 is performed and before operation 1820 is performed. For example, operation 610 may be performed before operation 1810 is performed.

According to one embodiment, the method of controlling power supplied to the heater, as described above with reference to FIG. 7, may be associated with operation 1820. For example, operations 710 and 720 may be performed before operation 1820 is performed, and operation 1820 may include operation 730.

In operation 1830, the aerosol-generating device may determine a first puff time during which the first puff is performed. For example, the aerosol-generating device may count the first puff time during the first puff. For example, after the first puff terminates, the aerosol-generating device may determine the first puff time as a difference between a time at which the first initiation command indicating the start of the first puff is obtained and a time at which the first termination command indicating the end of the first puff is obtained.

According to one embodiment, the method of determining the first puff time, as described above with reference to FIG. 10, may be associated with operation 1830. For example, operation 1010 may be performed before operation 1830 is performed, and operation 1830 may include operation 1020.

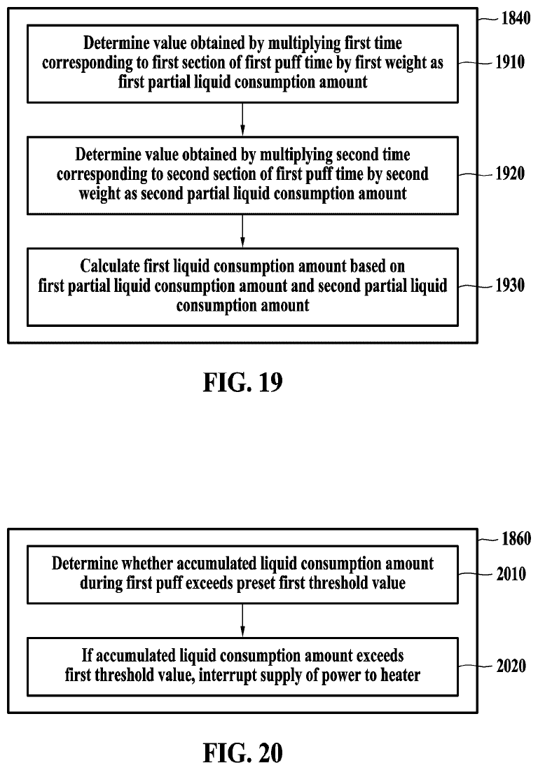

In operation 1840, the aerosol-generating device may calculate a first liquid consumption amount for an aerosol-generating substance based on the first atomization mode and the first puff time. The method of calculating the first liquid consumption amount corresponding to the first puff will be described in detail below with reference to FIG. 19.

According to one embodiment, the aerosol-generating substance may include a liquid composition. If the aerosol-generating substance is a liquid substance, the degree to which the aerosol-generating substance is consumed may be estimated based only on the power supplied to the heater corresponding to the atomization mode and the puff time.

In operation 1850, the aerosol-generating device may calculate an accumulated liquid consumption amount for the aerosol-generating substance based on the first liquid consumption amount. For example, the aerosol-generating device may calculate the accumulated liquid consumption amount corresponding to a mounted cartridge. For example, the aerosol-generating device may calculate the accumulated liquid consumption amount corresponding to the device. The aerosol-generating device may calculate the accumulated liquid consumption amount by summing all the liquid consumption amounts calculated for each previously performed puff.

In operation 1860, the aerosol-generating device may control the heater based on the accumulated liquid consumption amount. For example, the aerosol-generating device may control the operation of the heater corresponding to the ongoing first puff based on the accumulated liquid consumption amount. For example, the aerosol-generating device may control the operation of the heater corresponding to a second puff subsequently performed, based on the accumulated liquid consumption amount.

According to one embodiment, the method of outputting a notification indicating that the aerosol-generating substance is exhausted, as described above with reference to FIG. 12, may be associated with operation 1860. For example, operation 1210 may be performed after operation 1860 is performed.

FIG. 19 is a flowchart of a method of calculating a first liquid consumption amount for an aerosol-generating substance according to an example.

Operations 1910 to 1930 may be performed by an aerosol-generating device (e.g., the aerosol-generating device 1 of FIGS. 1 to 3). The aerosol-generating device may include a heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 1840 described above with reference to FIG. 18 may include operations 1910 to 1930.

According to one embodiment, the aerosol-generating device may estimate a degree to which the aerosol-generating substance is consumed during a first puff by calculating the first liquid consumption amount corresponding to the first puff. The aerosol-generating device may calculate the first liquid consumption amount by weighted-summing puff times respectively corresponding to a plurality of sections. By estimating the degree to which the aerosol-generating substance is consumed based on a first atomization mode and a first puff time, the aerosol-generating device may estimate the liquid consumption amount and a remaining liquid amount even without additional sensors such as a liquid level sensor for detecting a remaining amount of the aerosol-generating substance in a cartridge, or a temperature sensor for detecting a temperature of the heater.

According to one embodiment, the aerosol-generating device may store information about a look-up table of weights respectively corresponding to the plurality of sections for each of a plurality of atomization modes. The controller may calculate the first liquid consumption amount using the look-up table based on the first atomization mode and the first puff time.

In operation 1910, when the first puff time corresponds to a first section among a plurality of preset sections, the aerosol-generating device may determine a value obtained by multiplying a first time corresponding to a first section of a first puff time by a first weight as a first partial liquid consumption amount. For example, the first section may be a section from immediately after a start of the first puff to a preset first time. The first weight may be set to correspond to the first section and the first atomization mode. If the first section is a start section, the amount of aerosol generated in the first section may be less relative to the power supplied compared to other sections. Accordingly, the first weight for the first section may be less than weights for other sections.

In operation 1920, when the first puff time corresponds to a second section among the plurality of preset sections, the aerosol-generating device may determine a value obtained by multiplying a second time corresponding to a second section of the first puff time by a second weight as a second partial liquid consumption amount. For example, the second section may be a section following the first section. For example, the second section may be a section from the first time to a preset second time. The second weight may be set to correspond to the second section and the first atomization mode. The second weight for the second section may be greater than the first weight.

In operation 1930, the aerosol-generating device may calculate the first liquid consumption amount based on the first partial liquid consumption amount and the second partial liquid consumption amount. For example, the aerosol-generating device may calculate the first liquid consumption amount corresponding to the amount of the aerosol-generating substance consumed during the first puff by summing partial liquid consumption amounts for all sections corresponding to the first puff time.

The aerosol-generating device may generate an aerosol by supplying latent heat of vaporization to the aerosol-generating substance through power supplied to the heater and may thus estimate the degree to which the aerosol-generating substance is consumed based on the first atomization mode that determines a power profile. Because heat stored in the aerosol-generating substance may accumulate as the puff time elapses during the first puff, the degree to which the aerosol-generating substance is consumed may vary even when the same amount of power is supplied to the heater. The aerosol-generating device may accurately estimate the degree to which the aerosol-generating substance is consumed during the first puff by setting a plurality of sections based on changes in the power supplied to the heater and the elapse of the puff time and determining weights respectively corresponding to the plurality of sections.

FIG. 20 is a flowchart of a method of controlling a heater based on an accumulated liquid consumption amount during a first puff according to an example.

Operations 2010 and 2020 may be performed by an aerosol-generating device (e.g., the aerosol-generating device 1 of FIGS. 1 to 3). The aerosol-generating device may include the heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 1860 described above with reference to FIG. 18 may include operations 2010 and 2020.

According to one embodiment, the aerosol-generating device may count the first puff time during the first puff. The aerosol-generating device may determine whether an aerosol-generating substance is exhausted by calculating the accumulated liquid consumption amount that reflects, in real time, the exhaustion of the aerosol-generating substance during the first puff. If the exhaustion of the aerosol-generating substance during the first puff is reflected in real time in the accumulated liquid consumption amount, the aerosol-generating device may supply a maximum amount of aerosol to the user by maximizing the consumption of the aerosol-generating substance.

In operation 2010, the aerosol-generating device may determine whether the accumulated liquid consumption amount during the first puff exceeds a preset first threshold value. For example, the preset first threshold value may be a value corresponding to an entire amount of the aerosol-generating substance included in a cartridge mounted in the aerosol-generating device. If the accumulated liquid consumption amount exceeds the first threshold value, the aerosol-generating device may determine that the aerosol-generating substance is exhausted.

In operation 2020, if the accumulated liquid consumption amount exceeds the first threshold value, the aerosol-generating device may interrupt the supply of power to the heater. If it is determined that the aerosol-generating substance is exhausted, the aerosol-generating device may prevent a risk of a dry puff or damage to the device that may occur when the aerosol-generating substance is exhausted, by interrupting the supply of power to the heater.

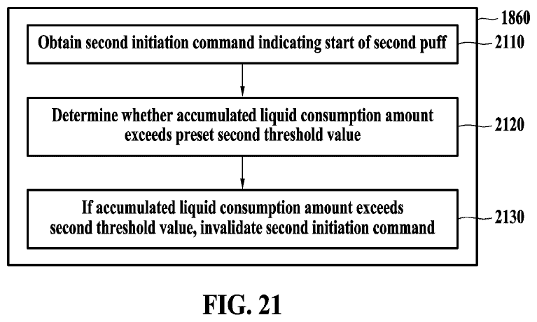

FIG. 21 is a flowchart of a method of controlling a heater based on an accumulated liquid consumption amount after a second initiation command is obtained according to an example.

Operations 2110 to 2130 may be performed by an aerosol-generating device (e.g., the aerosol-generating device 1 of FIGS. 1 to 3). The aerosol-generating device may include the heater (e.g., the heater 24 of FIGS. 1 to 3), a sensor unit (e.g., the sensor unit 13 of FIGS. 1 to 3), and a controller (e.g., the controller 12 of FIGS. 1 to 3). For example, operation 1860 described above with reference to FIG. 18 may include operations 2110 to 2130.

According to one embodiment, the aerosol-generating device may determine whether an aerosol-generating substance is exhausted at a start of a second puff following an end of a first puff. By determining whether the aerosol-generating substance is exhausted at the start of the second puff following the end of the first puff, the aerosol-generating device may prevent an aerosol from being generated when the aerosol-generating substance is insufficient in the cartridge.

In operation 2110, the aerosol-generating device may obtain the second initiation command indicating the start of the second puff. Regarding operation 2110, the description of operation 1810 provided above with reference to FIG. 18 may apply in the same or a similar manner.

In operation 2120, the aerosol-generating device may determine whether the accumulated liquid consumption amount exceeds a preset second threshold value. For example, the preset second threshold value may correspond to an amount of the aerosol-generating substance included in a cartridge mounted in the aerosol-generating device, excluding an amount required to perform one puff. If the accumulated liquid consumption amount exceeds the second threshold value, the aerosol-generating device may determine that the remaining amount of the aerosol-generating substance in the cartridge is insufficient to perform one puff.

In operation 2130, the aerosol-generating device may invalidate the second initiation command if the accumulated liquid consumption amount exceeds the second threshold value. If it is determined that the remaining amount of the aerosol-generating substance in the cartridge is insufficient to perform one puff, the aerosol-generating device may prevent a risk of a dry puff or damage to the device that may occur when the aerosol-generating substance is exhausted by interrupting the supply of power to the heater.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling a heater performed by an aerosol-generating device, the method comprising:
obtaining a first initiation command indicating a start of a first puff;
when the first initiation command is obtained, controlling power supplied to the heater to heat an aerosol-generating substance based on a first power profile set to correspond to a first atomization mode;
determining a first puff time during which the first puff is performed;
calculating a first weighted use time value for the aerosol-generating substance based on the first atomization mode and the first puff time;
calculating an accumulated use time value for the aerosol-generating substance based on the first weighted use time value; and
controlling the heater based on the accumulated use time value.

2. The method of claim 1, wherein the calculating of the first weighted use time value for the aerosol-generating substance comprises:
when the first puff time corresponds to a first section among a plurality of preset sections, determining a value obtained by multiplying a first weight by a first time corresponding to the first section of the first puff time as a first partial weighted use time value corresponding to the first section, wherein the first weight is set to correspond to the first section and the first atomization mode;
when the first puff time corresponds to a second section among the plurality of preset sections, determining a value obtained by multiplying a second weight by a second time corresponding to the second section of the first puff time as a second partial weighted use time value corresponding to the second section, wherein the second weight is set to correspond to the second section and the first atomization mode; and
calculating the first weighted use time value based on the first partial weighted use time value and the second partial weighted use time value.

3. The method of claim 1, wherein the controlling of the heater based on the accumulated use time value comprises:
determining whether the accumulated use time value exceeds a preset first threshold value during the first puff; and
when the accumulated use time value exceeds the first threshold value, interrupting the supply of power to the heater.

4. The method of claim 3, further comprising:
outputting a notification indicating that the aerosol-generating substance has been exhausted when the accumulated use time value exceeds the first threshold value during the first puff.

5. The method of claim 1, wherein the controlling of the heater based on the accumulated use time value comprises:
obtaining a second initiation command indicating a start of a second puff;
determining whether the accumulated use time value exceeds a preset second threshold value; and
when the accumulated use time value exceeds the second threshold value, invalidating the second initiation command.

6. The method of claim 5, further comprising:
outputting a notification indicating that the aerosol-generating substance has been exhausted when the accumulated use time value exceeds the second threshold value.

7. The method of claim 1, wherein the obtaining of the first initiation command indicating the start of the first puff comprises:
measuring a pressure of an airflow path through which gas flows in the aerosol-generating device using a pressure sensor; and
obtaining the first initiation command based on the measured pressure of the airflow path.

8. The method of claim 1, further comprising:
obtaining a first termination command indicating an end of the first puff,
wherein the determining of the first puff time during which the first puff is performed comprises:
determining a difference between a first time at which the first initiation command is obtained and a second time at which the first termination command is obtained as the first puff time.

9. The method of claim 1, further comprising:
determining a resistance of the heater,
wherein the controlling of the power supplied to the heater comprises:
adjusting a duty cycle of a signal provided to the heater based on the first power profile and the resistance of the heater.

10. The method of claim 9, further comprising:
determining a magnitude of a voltage supplied from a power supply of the aerosol-generating device,
wherein the adjusting of the duty cycle of the signal provided to the heater based on the first power profile and the resistance of the heater comprises:
adjusting the duty cycle of the signal provided to the heater based on the first power profile, the resistance of the heater, and the magnitude of the voltage supplied from the power supply.

11. The method of claim 1, further comprising:
determining the first atomization mode among a plurality of atomization modes based on a mode selection input by a user.

12. The method of claim 1, wherein the aerosol-generating substance comprises a liquid composition.

13. A non-transitory computer-readable storage medium storing instructions that are executable by a processor to perform the method of claim 1.

14. An aerosol-generating device comprising:
a controller configured to control an operation of the aerosol-generating device;
a sensor unit configured to generate measurement data corresponding to a start of a puff;
a power supply configured to supply power to the controller;
a cartridge including an aerosol-generating substance; and
a heater configured to heat the aerosol-generating substance,
wherein the controller is configured to:
obtain a first initiation command indicating a start of a first puff based on the measurement data;
when the first initiation command is obtained, control power supplied to the heater to heat the aerosol-generating substance based on a first power profile set to correspond to a first atomization mode;
determine a first puff time during which the first puff is performed;
calculate a first weighted use time value for the aerosol-generating substance based on the first atomization mode and the first puff time;
calculate an accumulated use time value for the aerosol-generating substance based on the first weighted use time value; and
control the heater based on the accumulated use time value.

15. The aerosol-generating device of claim 14, wherein the sensor unit comprises a pressure sensor configured to generate the measurement data by measuring a pressure of an airflow path through which gas flows in the aerosol-generating device.
